(19) United States
(12) Patent Application Publication
(10) Pub. No.: US 2024/0338785 A1
(43) Pub. Date: Oct. 10, 2024

(54) METHODS TO DEFEND AGAINST JUDICIAL EXCEPTIONS TO THE PATENT ACT AND INTELLECTUAL PROPERTY DERIVED THEREFROM

(71) Applicant: Douglas G. Metcalf, Boulder, CO (US)

(72) Inventor: Douglas G. Metcalf, Boulder, CO (US)

(21) Appl. No.: 18/739,414

(22) Filed: Jun. 11, 2024

Related U.S. Application Data
(60) Provisional application No. 63/575,713, filed on Apr. 6, 2024.

(51) Int. Cl. G06Q 50/18

(52) U.S. Cl. CPC G06Q 50/184

(57) ABSTRACT

Various aspects of this disclosure relate to methods to overcome subject-matter eligibility rejections during patent examination or subsequent proceedings and to defend against attempts to invalidate patent claims for lack of subject-matter eligibility. Other aspects of this disclosure relate to patent assets that are products of such methods. In general, the methods are premised upon the observation that judicial exceptions to federal statute violate the Supremacy Clause of the United States Constitution.

### CROSS-REFERENCE TO RELATED APPLICATIONS

This patent claims priority to U.S. Provisional Patent Application No. 63/575,713, filed Apr. 6, 2024, and U.S. Provisional Patent Application No. 63,657,876, filed Jun. 9, 2024, each of which is incorporated by reference in its entirety.

### BACKGROUND

Judicial exceptions to 35 U.S.C. § 101 extract a tremendous toll on the United States economy. Former Director of the United States Patent and Trademark Office (USPTO) Andrei Iancu commented, “‘[i] t's important for the judiciary to first recognize that there is a problem that needs to be addressed ‘. . . ’ 101 remains the most important substantive patent law issue in the United Statestoday. And it's not even close.’” Former Chief Judge of the Federal Circuit Paul Michel testified to Congress, “[u] nless this problem is resolved, our nation's innovation economy will weaken and our world leadership in science and technology will decline.” Chairman of the Senate Judiciary Subcommittee on Intellectual Property Senator Thom Tillis commented, “[w] hat we do on this subject will have major implications for every aspect of America's innovation economy, and it will determine if the United States remains the world's leading innovator in the 21st Century.” A solution to this problem would display immense value.

### SUMMARY

Various aspects of this disclosure relate to methods to rebut a judicial exception to the Patent Act by demonstrating that judicial exceptions violate the Supremacy Clause of the United States Constitution. Various aspects of this disclosure relate to intellectual property that matures from methods of this disclosure.

### DETAILED DESCRIPTION

Various aspects of this disclosure relate to a method to demonstrate the subject-matter eligibility of a patent claim, comprising identifying that a judicial exception to statutory subject matter violates the Supremacy Clause of the United States Constitution, wherein the patent claim is a claim of a patent or a patent application.

The word “method” is a synonym of the word “process” in the context of this disclosure, and the word “method” may optionally be replaced with the word “process,” for example, to provide written description for claims that use the word “process” instead of the word “method.”

In some embodiments, the judicial exception is selected from a rationale set forth in one or more of Alice Corp. Party v. CLS Bank Int'l, 573 U.S. 208 (2014), Ass'n for Molecular Pathology v. Myriad Genetics, Inc., 569 U.S. 576 (2013), Mayo Collaborative Servs. v. Prometheus Labs., Inc., 566 U.S. 66 (2012), Bilski v. Kappos, 561 U.S. 593 (2010), Parker v. Flook, 437 U.S. 584 (1978), Gottschalk v. Benson, 409 U.S. 63 (1972), Funk Bros. Seed Co. v. Kalo Inoculant Co., 333 U.S. 127 (1948), and one or more other USPTO or judicial opinions that cite any of the foregoing. In some specific embodiments, the judicial exception is selected from a rationale set forth in one or more of Alice, Myriad, Mayo, Bilski, Flook, Benson, and Funk Bros. In some very specific embodiments, the judicial exception is selected from a rationale set forth in one or more of Alice, Myriad, and Mayo.

In some embodiments, the statutory subject matter is set forth in Title 35 of the United States Code. In some specific embodiments, the statutory subject matter is set forth in Title 35, Section 101 of the United States Code (35 U.S.C. § 101).

In some embodiments, the identifying is performed during a legal proceeding that contests the patentability of the claim, and the legal proceeding has a record.

In some embodiments, the method comprises filing a brief in the record. In some specific embodiments, the identifying comprises filing a brief in the record. In some very specific embodiments, the identifying comprises filing a brief in the record, and the brief identifies that the judicial exception to statutory subject matter violates the Supremacy Clause of the United States Constitution.

In some embodiments, the identifying cites one or more of Alice, Myriad, Mayo, Bilski, Flook, Benson, Funk Bros., and one or more other judicial opinions that cite any of the foregoing. In some specific embodiments, the identifying cites one or more of Alice, Myriad, Mayo, Bilski, Flook, Benson, and Funk Bros. In some very specific embodiments, the identifying cites one or more of Alice, Myriad, and Mayo.

In some embodiments, the brief cites one or more of Alice, Myriad, Mayo, Bilski, Flook, Benson, Funk Bros., and one or more other judicial opinions that cite any of the foregoing. In some specific embodiments, the brief cites one or more of Alice, Myriad, Mayo, Bilski, Flook, Benson, and Funk Bros. In some very specific embodiments, the brief cites one or more of Alice, Myriad, and Mayo.

In some embodiments the brief cites one or more of U.S. CONST. art. I, § 8, cl. 3; U.S. CONST. art. I, § 8, cl. 18; U.S. CONST. art. VI, cl. 2; U.S. CONST. art. VI, cl. 3; Dobbs v. Jackson Women's Health Org., 597 U.S. 215 (2022); Jackson Women's Health, 597 U.S. 215 (Kagan, J., dissenting); Minerva Surgical, Inc. v. Hologic, Inc., 141 S. Ct. 2298 (2021) (Barrett, J., dissenting); Bostock v. Clayton Cnty., 140 S. Ct. 1731 (2020); Bostock, 140 S. Ct. 1731 (Kavanaugh, J., dissenting); Gamble v. United States, 139 S. Ct. 1960 (2019) (Thomas, J., dissenting); Gamble, 139 S. Ct. 1960 (Gorsuch, J., dissenting); Murphy v. Nat'l Collegiate Athletic Ass'n, 584 U.S. 453 (2018); SCA Hygiene Prods. Aktiebolag v. First Quality Baby Prods., LLC, 580 U.S. 328 (2017); Kimble v. Marvel Entm't, LLC, 576 U.S. 446 (2015); Marvel Entm't, 576 U.S. 446 (Alito, J., dissenting); Wellness Int'l Network, Ltd. v. Sharif, 575 U.S. 665 (2015) (Roberts, C. J., dissenting); Perez v. Mortg. Bankers Ass'n, 575 U.S. 92 (2015); Armour v. City of Indianapolis, 566 U.S. 673 (2012); Zivotofsky v. Clinton, 566 U.S. 189 (2012); Microsoft Corp. v. i4i Ltd. P'ship, 564 U.S. 91 (2011); Milner v. Dep't of the Navy, 562 U.S. 562 (2011); United States v. Comstock, 560 U.S. 126 (2010); Comstock, 560 U.S. 126 (Thomas, J., dissenting); Citizens United v. Fed. Election Comm'n, 558 U.S. 310 (2010) (Roberts, C. J., concurring); Bilski v. Doll, 556 U.S. 1268 (2009); Arizona v. Gant, 556 U.S. 332 (2009); Safeco Ins. Co. of America v. Burr, 551 U.S. 47 (2007); Gonzales v. Raich, 545 U.S. 1 (2005); Lawrence v. Texas, 539 U.S. 558 (2003); Eldred v. Ashcroft, 537 U.S. 186 (2003); Whitman v. Am. Trucking Ass'ns, 531 U.S. 457 (2001); Washington v. Glucksberg, 521 U.S. 702 (1997); Agostini v. Felton, 521 U.S. 203 (1997); United States v. Lopez, 514 U.S. 549 (1995); Reno v. Flores, 507 U.S. 292 (1993); Pension Benefit Guar. Corp. v. LTV Corp., 496 U.S. 633 (1990); Sec. Indus. Ass'n v. Bd. of Governors of Fed. Reserve Sys., 468 U.S. 137 (1984); Am. Tobacco Co. v. Patterson, 456 U.S. 63 (1982); Dawson Chem. Co. v. Rohm & Haas Co., 448 U.S. 176 (1980); United States v. Rutherford, 442 U.S. 544 (1979); Tenn. Valley Auth. v. Hill, 437 U.S. 153 (1979); New Orleans v. Dukes, 427 U.S. 297 (1976); Usery v. Turner Elkhorn Mining Co., 428 U.S. 1 (1976); Shultz v. Moore, 419 U.S. 930 (1974) (Douglas, J., dissenting); Roe v. Wade, 410 U.S. 113 (1973); Deepsouth Packing Co. v. Laitram Corp., 406 U.S. 518 (1972); Griswold v. Connecticut, 381 U.S. 479 (1965); United States v. Seeger, 380 U.S. 163 (1965) (Douglas, J., concurring); Ferguson v. Skrupa, 372 U.S. 726 (1963); Williamson v. Lee Optical of Oklahoma, Inc., 348 U.S. 483 (1955); Brown v. Bd. of Educ., 347 U.S. 483 (1954); Rosenberg v. United States, 346 U.S. 273 (1953); United States v. Rumely, 345 U.S. 41 (1953); Rumely, 345 U.S. 41 (1953) (Douglas, J., concurring); Day-Brite Lighting, Inc. v. Missouri, 342 U.S. 421 (1952); United States v. Wunderlich, 342 U.S. 98 (1951) (Douglas, J., dissenting); Dennis v. United States, 341 U.S. 494 (1951) (Frankfurter, J., concurring); Screws v. United States, 325 U.S. 91 (1945); Skinner v. Oklahoma, 316 U.S. 535 (1942); United States v. Masonite Corp., 316 U.S. 265 (1942); Wickard v. Filburn, 317 U.S. 111 (1942); Olsen v. Nebraska, 313 U.S. 236 (1941); United States v. Darby, 312 U.S. 100 (1941); United States v. Carolene Products Co., 304 U.S. 144 (1938); Ashwander v. Tenn. Valley Auth., 297 U.S. 288 (1936) (Brandeis, J., concurring); United States v. Dubilier Condenser Corp., 289 U.S. 178 (1933); Burnet v. Coronado Oil & Gas Co., 285 U.S. 393 (1932) (Brandeis, J., dissenting); Crowell v. Benson, 285 U.S. 22 (1932); Crooks v. Harrelson, 282 U.S. 55 (1930); Ribnik v. McBride, 277 U.S. 350 (1928) (Stone, J., dissenting); Tyson & Brother United Theatre Ticket Offs. v. Banton, 273 U.S. 418 (1927) (Holmes, J., dissenting); Jay Burns Baking Co. v. Bryan, 264 U.S. 504 (1924) (Brandeis, J., dissenting); Washington v. W. C. Dawson & Co., 264 U.S. 219 (1924) (Brandeis, J., dissenting); Adkins v. Children's Hosp. of the District of Colombia, 261 U.S. 525 (1923); Adkins, 261 U.S. 525 (Holmes, J., dissenting); United States v. Nice, 241 U.S. 591 (1916); United States v. Societe Anonyme Des Anciens Etablissements Cail, 224 U.S. 309 (1912); Lochner v. New York, 198 U.S. 45 (1905); Lochner, 198 U.S. 45 (Holmes, J., dissenting); In re Heff, 197 U.S. 488 (1905); Swift & Co. v. United States, 196 U.S. 375 (1905); United States v. Goldenberg, 168 U.S. 95 (1897); McKee v. United States, 164 U.S. 287 (1896); Risdon Iron & Locomotive Works v. Medart, 158 U.S. 68 (1895); United States v. E.C. Knight Co., 156 U.S. 1 (1895); Church of the Holy Trinity v. United States, 143 U.S. 457 (1892); Liverpool, New York & Philadelphia S.S. Co. v. Comm'rs of Emigration, 113 U.S. 33 (1885); United States v. Steffens (The Trade-Mark Cases), 100 U.S. 82 (1879); Munn v. Illinois, 94 U.S. 113 (1877); Veazie Bank v. Fenno, 75 U.S. (8. Wall.) 533 (1869); Marshall v. Baltimore & Ohio R.R., 57 U.S. (16 How.) 314 (1854) (Daniel, J., dissenting); Cary v. Curtis, 44 U.S. (3 How.) 236 (1845) (Story, J., dissenting); McClurg v. Kingsland, 42 U.S. (1 How.) 202 (1843); Gibbons v. Ogden, 22 U.S. (9 Wheat.) 1 (1824); McCulloch v. Maryland, 17 U.S. (4 Wheat.) 316 (1819); Marbury v. Madison, 5 U.S. (1 Cranch) 137 (1803); Blanchard v. Sprague, 3 F. Cas. 648 (C.C.D. Mass. 1839) (No. 1518) (Story, J.); THE FEDERALIST NO. 47 (James Madison); THE FEDERALIST NO. 51 (James Madison); THE FEDERALIST NO. 78 (Alexander Hamilton); HOWARD BALL & PHILLIP J. COOPER, OF POWER AND RIGHT (1992); Sir Rupert Cross & J. W. Harris, Introduction to PRECEDENT IN ENGLISH LAW (4th ed. 1991); ROBERT A. CARO, MEANS OF ASCENT (1990); THE DOUGLAS LETTERS (Melvin I. Urofsky ed., 1987); WILLIAM O. DOUGLAS, THE COURT YEARS (1980); BOB WOODWARD & SCOTT ARMSTRONG, THE BRETHREN (1979); WILLIAM O. DOUGLAS, GO EAST, YOUNG MAN (1974); ROBERT SHOGAN, A QUESTION OF JUDGMENT (1972); MONTESQUIEU, THE SPIRIT OF THE LAWS (1748); Matthew Sag, Tonja Jacobi & Maxim Sytch, Ideology and Exceptionalism in Intellectual Property: An Empirical Study, 97 CALIF. L. REV. 801 (2009); Andrew D. Martin & Kevin M. Quinn, Dynamic Ideal Point Estimation via Markov Chain Monte Carlo for the U.S. Supreme Court, 1953-1999, 10 POL. ANALYSIS. 134 (2002); and Nat Hentoff, The Justice Breaks His Silence, PLAYBOY MAG., July 1991. In some specific embodiments the brief cites one or more of U.S. CONST. art. I, § 8, cl. 3; U.S. CONST. art. I, § 8, cl. 18; U.S. CONST. art. VI, cl. 2; U.S. CONST. art. VI, cl. 3; Jackson Women's Health, 597 U.S. 215; Minerva Surgical, 141 S. Ct. 2298 (Barrett, J., dissenting); Gamble, 139 S. Ct. 1960 (Thomas, J., dissenting); Patterson, 456 U.S. 63; Rutherford, 442 U.S. 544; Hill, 437 U.S. 153; Dukes, 427 U.S. 297; Carolene Products, 304 U.S. 144; Coronado Oil & Gas, 285 U.S. 393 (Brandeis, J., dissenting); Harrelson, 282 U.S. 55; Goldenberg, 168 U.S. 95; Church of the Holy Trinity, 143 U.S. 457; McClurg, 42 U.S. (1 How.) 202; Gibbons, 22 U.S. (9 Wheat.) 1; McCulloch, 17 U.S. (4 Wheat.) 316; and Marbury, 5 U.S. (1 Cranch) 137. In some very specific embodiments the brief cites one or more of U.S. CONST. art. VI, cl. 2; U.S. CONST. art. VI, cl. 3; Jackson Women's Health, 597 U.S. 215; Gamble, 139 S. Ct. 1960 (Thomas, J., dissenting); Rutherford, 442 U.S. 544; Hill, 437 U.S. 153; Dukes, 427 U.S. 297; Carolene Products, 304 U.S. 144; Coronado Oil & Gas, 285 U.S. 393 (Brandeis, J., dissenting); Harrelson, 282 U.S. 55; Goldenberg, 168 U.S. 95; Church of the Holy Trinity, 143 U.S. 457; and Marbury, 5 U.S. (1 Cranch) 137.

In some embodiments, the patent or patent application is a United States patent.

In some embodiments, the legal proceeding is litigation.

In some embodiments, the legal proceeding is a proceeding before a court established under Article III of the Constitution of the United States. Relevant courts established under Article III of the Constitution of the United States currently include United States district courts, the United States Court of Federal Claims, the United States Court of Appeals for the Federal Circuit, and the Supreme Court of the United States.

In some embodiments, the legal proceeding is litigation before a United Status district court.

In some embodiments, the legal proceeding is litigation before the United States Court of Federal Claims.

In some embodiments, the legal proceeding is an appeal before the United States Court of Appeals for the Federal Circuit.

In some embodiments, the legal proceeding is an appeal before the Supreme Court of the United States.

The definite article “the” is used to in relation to the United States Court of Federal Claims, the United States Court of Appeals for the Federal Circuit, and the Supreme Court of the United States in the absence of explicit antecedent basis to avoid awkward legalese, and the skilled person will understand, for example, that “the Supreme Court of the United States” refers to any Supreme Court of the United States and not, for example, the Supreme Court of the United States as it existed on the priority date of this patent document. Like use of the definite article “the” shall be construed analogously throughout this disclosure, for example, such that the United States International Trade Commission, the Patent Trial and Appeal Board of the USPTO (“PTAB”), and the USPTO are not limited to unreasonable literal constructions.

In some embodiments, the legal proceeding is a proceeding before a United States federal administrative court.

In some embodiments, the legal proceeding is a proceeding before the United States International Trade Commission.

In some embodiments, the method comprises executing an agreement that settles the legal proceeding.

In some embodiments, the method comprises obtaining an injunction that enjoins a person from infringing the claim.

The term “person” refers to natural persons and business entities in the absence of context that suggests otherwise.

In some embodiments, the method comprises obtaining a damages award for infringement of the claim.

In some embodiments, the legal proceeding is a proceeding before the PTAB.

In some embodiments, the legal proceeding is a Post Grant Review.

In some embodiments, the method comprises enforcing the claim in a parallel or subsequent proceeding before either a court established under Article III of the Constitution of the United States or the United States International Trade Commission following conclusion of the proceeding before the PTAB.

In some embodiments, the method comprises obtaining an injunction that enjoins a person from infringing the claim during the parallel or subsequent proceeding.

In some embodiments, the method comprises obtaining a damages award for infringement of the claim during the parallel or subsequent proceeding.

In some embodiments, the method comprises executing an agreement that settles the parallel or subsequent proceeding.

In some embodiments, the legal proceeding includes an adverse party, and the parallel or subsequent proceeding includes the same adverse party.

In some embodiments, the legal proceeding includes an adverse party, and the parallel or subsequent proceeding includes a different adverse party.

In some embodiments, the patent or patent application is a United States patent application. In some embodiments, the legal proceeding is patent examination before the USPTO.

In some embodiments, the method comprises filing one or both of remarks and arguments in the record. In some specific embodiments, the identifying comprises filing one or both of remarks and arguments in the record. In some very specific embodiments, the identifying comprises filing one or both of remarks and arguments in the record; and the remarks and/or arguments identify that the judicial exception to statutory subject matter violates the Supremacy Clause of the United States Constitution.

In some embodiments, the method comprises filing a response to an office action in the record. In some specific embodiments, the identifying comprises filing a response to an office action in the record. In some very specific embodiments, the identifying comprises filing a response to an office action in the record, and the response identifies that the judicial exception to statutory subject matter violates the Supremacy Clause of the United States Constitution.

In some embodiments the response cites one or more of U.S. CONST. art. I, § 8, cl. 3; U.S. CONST. art. I, § 8, cl. 18; U.S. CONST. art. VI, cl. 2; U.S. CONST. art. VI, cl. 3; Dobbs v. Jackson Women's Health Org., 597 U.S. 215 (2022); Jackson Women's Health, 597 U.S. 215 (Kagan, J., dissenting); Minerva Surgical, Inc. v. Hologic, Inc., 141 S. Ct. 2298 (2021) (Barrett, J., dissenting); Bostock v. Clayton Cnty., 140 S. Ct. 1731 (2020); Bostock, 140 S. Ct. 1731 (Kavanaugh, J., dissenting); Gamble v. United States, 139 S. Ct. 1960 (2019) (Thomas, J., dissenting); Gamble, 139 S. Ct. 1960 (Gorsuch, J., dissenting); Murphy v. Nat'l Collegiate Athletic Ass'n, 584 U.S. 453 (2018); SCA Hygiene Prods. Aktiebolag v. First Quality Baby Prods., LLC, 580 U.S. 328 (2017); Kimble v. Marvel Entm't, LLC, 576 U.S. 446 (2015); Marvel Entm't, 576 U.S. 446 (Alito, J., dissenting); Wellness Int'l Network, Ltd. v. Sharif, 575 U.S. 665 (2015) (Roberts, C. J., dissenting); Perez v. Mortg. Bankers Ass'n, 575 U.S. 92 (2015); Armour v. City of Indianapolis, 566 U.S. 673 (2012); Zivotofsky v. Clinton, 566 U.S. 189 (2012); Microsoft Corp. v. i4i Ltd. P'ship, 564 U.S. 91 (2011); Milner v. Dep't of the Navy, 562 U.S. 562 (2011); United States v. Comstock, 560 U.S. 126 (2010); Comstock, 560 U.S. 126 (Thomas, J., dissenting); Citizens United v. Fed. Election Comm'n, 558 U.S. 310 (2010) (Roberts, C. J., concurring); Bilski v. Doll, 556 U.S. 1268 (2009); Arizona v. Gant, 556 U.S. 332 (2009); Safeco Ins. Co. of America v. Burr, 551 U.S. 47 (2007); Gonzales v. Raich, 545 U.S. 1 (2005); Lawrence v. Texas, 539 U.S. 558 (2003); Eldred v. Ashcroft, 537 U.S. 186 (2003); Whitman v. Am. Trucking Ass'ns, 531 U.S. 457 (2001); Washington v. Glucksberg, 521 U.S. 702 (1997); Agostini v. Felton, 521 U.S. 203 (1997); United States v. Lopez, 514 U.S. 549 (1995); Reno v. Flores, 507 U.S. 292 (1993); Pension Benefit Guar. Corp. v. LTV Corp., 496 U.S. 633 (1990); Sec. Indus. Ass'n v. Bd. of Governors of Fed. Reserve Sys., 468 U.S. 137 (1984); Am. Tobacco Co. v. Patterson, 456 U.S. 63 (1982); Dawson Chem. Co. v. Rohm & Haas Co., 448 U.S. 176 (1980); United States v. Rutherford, 442 U.S. 544 (1979); Tenn. Valley Auth. v. Hill, 437 U.S. 153 (1979); New Orleans v. Dukes, 427 U.S. 297 (1976); Usery v. Turner Elkhorn Mining Co., 428 U.S. 1 (1976); Shultz v. Moore, 419 U.S. 930 (1974) (Douglas, J., dissenting); Roe v. Wade, 410 U.S. 113 (1973); Deepsouth Packing Co. v. Laitram Corp., 406 U.S. 518 (1972); Griswold v. Connecticut, 381 U.S. 479 (1965); United States v. Seeger, 380 U.S. 163 (1965) (Douglas, J., concurring); Ferguson v. Skrupa, 372 U.S. 726 (1963); Williamson v. Lee Optical of Oklahoma, Inc., 348 U.S. 483 (1955); Brown v. Bd. of Educ., 347 U.S. 483 (1954); Rosenberg v. United States, 346 U.S. 273 (1953); United States v. Rumely, 345 U.S. 41 (1953); Rumely, 345 U.S. 41 (1953) (Douglas, J., concurring); Day-Brite Lighting, Inc. v. Missouri, 342 U.S. 421 (1952); United States v. Wunderlich, 342 U.S. 98 (1951) (Douglas, J., dissenting); Dennis v. United States, 341 U.S. 494 (1951) (Frankfurter, J., concurring); Screws v. United States, 325 U.S. 91 (1945); Skinner v. Oklahoma, 316 U.S. 535 (1942); United States v. Masonite Corp., 316 U.S. 265 (1942); Wickard v. Filburn, 317 U.S. 111 (1942); Olsen v. Nebraska, 313 U.S. 236 (1941); United States v. Darby, 312 U.S. 100 (1941); United States v. Carolene Products Co., 304 U.S. 144 (1938); Ashwander v. Tenn. Valley Auth., 297 U.S. 288 (1936) (Brandeis, J., concurring); United States v. Dubilier Condenser Corp., 289 U.S. 178 (1933); Burnet v. Coronado Oil & Gas Co., 285 U.S. 393 (1932) (Brandeis, J., dissenting); Crowell v. Benson, 285 U.S. 22 (1932); Crooks v. Harrelson, 282 U.S. 55 (1930); Ribnik v. McBride, 277 U.S. 350 (1928) (Stone, J., dissenting); Tyson & Brother—United Theatre Ticket Offs. v. Banton, 273 U.S. 418 (1927) (Holmes, J., dissenting); Jay Burns Baking Co. v. Bryan, 264 U.S. 504 (1924) (Brandeis, J., dissenting); Washington v. W.C. Dawson & Co., 264 U.S. 219 (1924) (Brandeis, J., dissenting); Adkins v. Children's Hosp. of the District of Colombia, 261 U.S. 525 (1923); Adkins, 261 U.S. 525 (Holmes, J., dissenting); United States v. Nice, 241 U.S. 591 (1916); United States v. Societe Anonyme Des Anciens Etablissements Cail, 224 U.S. 309 (1912); Lochner v. New York, 198 U.S. 45 (1905); Lochner, 198 U.S. 45 (Holmes, J., dissenting); In re Heff, 197 U.S. 488 (1905); Swift & Co. v. United States, 196 U.S. 375 (1905); United States v. Goldenberg, 168 U.S. 95 (1897); McKee v. United States, 164 U.S. 287 (1896); Risdon Iron & Locomotive Works v. Medart, 158 U.S. 68 (1895); United States v. E.C. Knight Co., 156 U.S. 1 (1895); Church of the Holy Trinity v. United States, 143 U.S. 457 (1892); Liverpool, New York & Philadelphia S.S. Co. v. Comm'rs of Emigration, 113 U.S. 33 (1885); United States v. Steffens (The Trade-Mark Cases), 100 U.S. 82 (1879); Munn v. Illinois, 94 U.S. 113 (1877); Veazie Bank v. Fenno, 75 U.S. (8. Wall.) 533 (1869); Marshall v. Baltimore & Ohio R.R., 57 U.S. (16 How.) 314 (1854) (Daniel, J., dissenting); Cary v. Curtis, 44 U.S. (3 How.) 236 (1845) (Story, J., dissenting); McClurg v. Kingsland, 42 U.S. (1 How.) 202 (1843); Gibbons v. Ogden, 22 U.S. (9 Wheat.) 1 (1824); McCulloch v. Maryland, 17 U.S. (4 Wheat.) 316 (1819); Marbury v. Madison, 5 U.S. (1 Cranch) 137 (1803); Blanchard v. Sprague, 3 F. Cas. 648 (C.C.D. Mass. 1839) (No. 1518) (Story, J.); THE FEDERALIST NO. 47 (James Madison); THE FEDERALIST NO. 51 (James Madison); THE FEDERALIST NO. 78 (Alexander Hamilton); HOWARD BALL & PHILLIP J. COOPER, OF POWER AND RIGHT (1992); Sir Rupert Cross & J. W. Harris, Introduction to PRECEDENT IN ENGLISH LAW (4th ed. 1991); ROBERT A. CARO, MEANS OF ASCENT (1990); THE DOUGLAS LETTERS (Melvin I. Urofsky ed., 1987); WILLIAM O. DOUGLAS, THE COURT YEARS (1980); BOB WOODWARD & SCOTT ARMSTRONG, THE BRETHREN (1979); WILLIAM O. DOUGLAS, GO EAST, YOUNG MAN (1974); ROBERT SHOGAN, A QUESTION OF JUDGMENT (1972); MONTESQUIEU, THE SPIRIT OF THE LAWS (1748); Matthew Sag, Tonja Jacobi & Maxim Sytch, Ideology and Exceptionalism in Intellectual Property: An Empirical Study, 97 CALIF. L. REV. 801 (2009); Andrew D. Martin & Kevin M. Quinn, Dynamic Ideal Point Estimation via Markov Chain Monte Carlo for the U.S. Supreme Court, 1953-1999, 10 POL. ANALYSIS. 134 (2002); and Nat Hentoff, The Justice Breaks His Silence, PLAYBOY MAG., July 1991. In some specific embodiments the response cites one or more of U.S. CONST. art. I, § 8, cl. 3; U.S. CONST. art. I, § 8, cl. 18; U.S. CONST. art. VI, cl. 2; U.S. CONST. art. VI, cl. 3; Jackson Women's Health, 597 U.S. 215; Minerva Surgical, 141 S. Ct. 2298 (Barrett, J., dissenting); Gamble, 139 S. Ct. 1960 (Thomas, J., dissenting); Patterson, 456 U.S. 63; Rutherford, 442 U.S. 544; Hill, 437 U.S. 153; Dukes, 427 U.S. 297; Carolene Products, 304 U.S. 144; Coronado Oil & Gas, 285 U.S. 393 (Brandeis, J., dissenting); Harrelson, 282 U.S. 55; Goldenberg, 168 U.S. 95; Church of the Holy Trinity, 143 U.S. 457; McClurg, 42 U.S. (1 How.) 202; Gibbons, 22 U.S. (9 Wheat.) 1; McCulloch, 17 U.S. (4 Wheat.) 316; and Marbury, 5 U.S. (1 Cranch) 137. In some very specific embodiments the response cites one or more of U.S. CONST. art. VI, cl. 2; U.S. CONST. art. VI, cl. 3; Jackson Women's Health, 597 U.S. 215; Gamble, 139 S. Ct. 1960 (Thomas, J., dissenting); Rutherford, 442 U.S. 544; Hill, 437 U.S. 153; Dukes, 427 U.S. 297; Carolene Products, 304 U.S. 144; Coronado Oil & Gas, 285 U.S. 393 (Brandeis, J., dissenting); Harrelson, 282 U.S. 55; Goldenberg, 168 U.S. 95; Church of the Holy Trinity, 143 U.S. 457; and Marbury, 5 U.S. (1 Cranch) 137.

In some embodiments, the method comprises paying an issue fee in the United States patent application, wherein a United States patent grants from the United States patent application following payment of the issue fee.

In some embodiments, the method comprises paying an issue fee in the United States patent application, wherein a United States patent grants from the United States patent application following payment of the issue fee, and the United States patent includes the claim. In some embodiments, the United States patent application matures into a United States patent, and the method comprises paying a maintenance fee to maintain the United States patent in force.

In some embodiments, the United States patent application matures into a United States patent that includes the claim, and the method comprises paying a maintenance fee to maintain the United States patent in force.

In some embodiments, the method comprises executing an agreement that assigns an ownership interest in the United States patent application.

In some embodiments, the method comprises executing an agreement that assigns an ownership interest in the either the United States patent application, a parent patent application to which the United States patent application claims priority, a child patent application that claims priority to the United States patent application, a United States patent that matures from the United States patent application, a child United States patent that matures from any child patent application, a parent United States patent that matures from any parent patent application, or a combination of two or more of the foregoing.

In some embodiments, the method comprises executing an agreement that licenses an interest in the United States patent application.

In some embodiments, the claim has a scope, and the method comprises executing an agreement that licenses a right to practice an invention that falls within the scope of the claim.

In some embodiments, the method comprises executing an agreement that comprises a covenant against patent infringement litigation in relation to the Untied States patent application.

In some embodiments, the method comprises executing an agreement that comprises a covenant against patent infringement litigation in relation to the claim.

In some embodiments, the claim has a scope, and the method comprises executing an agreement that comprises a covenant against patent infringement litigation in relation to an invention that falls within the scope of the claim.

In some embodiments, a United States patent matures from the United States patent application; the United States patent has a serial number; and the method comprises labeling a product with the serial number to indicate that the product is protected by the United States patent.

In some embodiments, a United States patent matures from the United States patent application; the United States patent has a serial number; and the method comprises marking marketing materials with the serial number to indicate that a subject of the marketing materials is protected by the United States patent.

In some embodiments, a United States patent matures from the United States patent application; the United States patent comprises the claim; and the method comprises asserting an infringement claim of infringement of the claim during litigation to enforce the United States patent.

In some embodiments, the method comprises executing an agreement that settles the litigation.

In some embodiments, a United States patent that comprises the claim matures from the United States patent application, and the method comprises obtaining a damages award for infringement of the claim.

In some embodiments, a United States patent that comprises the claim matures from the United States patent application, and the method comprises obtaining an injunction that enjoins a person from infringing the claim.

In some embodiments, the method is a strategic method. In some embodiments, the strategic method is any permutation of the preceding embodiments. In some specific embodiments, the strategic method is any permutation of the preceding embodiments that grammar and logic allow. In some very specific embodiments, the strategic method is any permutation of the preceding embodiments that grammar, logic, and legal procedure allow. Selected permutations may be identified, for example, in the claim set of U.S. 63/575,713, to which the instant application claims priority.

Various aspects of this disclosure relate to a method to obtain a United States patent, comprising paying an issue fee in a United States patent application that has a prosecution history before the USPTO, wherein a portion of the prosecution history is a product of a strategic method as described herein.

Various aspects of this disclosure relate to a method to change ownership of a patent asset that is a United States patent application or a United States patent, comprising executing an agreement that assigns the patent asset, wherein the patent asset has a prosecution history before the USPTO, and a portion of the prosecution history is a product of a strategic method as described herein.

Various aspects of this disclosure relate to a method to license a patent asset that is a United States patent application or a United States patent, comprising executing an agreement that licenses the patent asset, wherein the patent asset has a prosecution history before the USPTO, and a portion of the prosecution history is a product of a strategic method as described herein.

Various aspects of this disclosure relate to a method to maximize the enforcement value of a United States patent that has a serial number, comprising labeling a product with the serial number to indicate that the product is protected by the United States patent, wherein the United States patent has a prosecution history before the USPTO, and a portion of the prosecution history is a product of a strategic method as described herein.

In some embodiments, the method comprises selling the product.

Various aspects of this disclosure relate to a method to maximize the enforcement value of a United States patent that has a serial number, comprising labeling marketing materials with the serial number to indicate that a subject of the marketing materials is protected by the United States patent, wherein the United States patent has a prosecution history before the USPTO, and a portion of the prosecution history is a product of a strategic method as described herein.

In some embodiments, the subject of the marketing materials is a marketed product.

In some embodiments, the method comprises manufacturing the marketed product.

In some embodiments, the method comprises selling the marketed product.

In some embodiments, the subject of the marketing materials is a marketed service.

In some embodiments, the method comprises selling the marketed service.

In some embodiments, the method comprises performing the marketed service.

Various aspects of this disclosure relate to a method to maintain a United States patent in force, comprising paying a maintenance fee to maintain the United States patent in force, wherein the United States patent has a prosecution history before the USPTO, and a portion of the prosecution history is a product of a strategic method as described herein.

Various aspects of this disclosure relate to a method to enforce a United States patent, comprising asserting an infringement claim of infringement of the United States patent in either a United States federal court established under Article III of the Constitution of the United States or the United States International Trade Commission, wherein the United States patent has a prosecution history before the USPTO, and a portion of the prosecution history is a product of a strategic method as described herein.

In some embodiments, the method comprises obtaining an injunction that enjoins a person from infringing an infringed claim of the United States patent. In some specific embodiments, the infringed claim is the claim.

In some embodiments, the method comprises obtaining a damages award for infringement of the United States patent.

In some embodiments, the method comprises executing an agreement that settles the infringement claim.

In some embodiments, the patent or patent application is the United States patent application, and the portion of the prosecution history is immediate prosecution history of the United States patent application.

In some embodiments, the patent or patent application is the United States patent application, and the portion of the prosecution history comprises parent prosecution history of one or more parent United States patent applications to which the United States patent application claims priority.

In some embodiments, the portion of the prosecution history comprises immediate prosecution history of an immediate United States patent application from which the United States patent granted.

In some embodiments, the patent or patent application is the immediate United States patent application.

In some embodiments, the portion of the prosecution history comprises parent prosecution history of one or more parent United States patent applications to which the United States patent claims priority.

In some embodiments, the patent or patent application is a parent United States patent application of the United States patent and the United States patent application.

In some embodiments, the method comprises performing the strategic method.

In some embodiments, the method is performed by one or more of inventors, applicants, assignors, assignees, licensors, licensees, registered patent agents, registered patent attorneys, other attorneys, and law firms. In some specific embodiments, any permutation of the preceding embodiments is performed by one or more of inventors, applicants, assignors, assignees, licensors, licensees, registered patent agents, registered patent attorneys, other attorneys, and law firms. Selected permutations may be identified, for example, in the claim set of U.S. 63/575,713, to which the instant application claims priority.

In some embodiments, one or more inventors of the one or more parent United States patent applications perform the method or a portion of the method.

In some embodiments, one or more applicants of the one or more parent United States patent applications perform the method or a portion of the method.

In some embodiments, one or more assignors of the one or more parent United States patent applications perform the method or a portion of the method.

In some embodiments, one or more assignees of the one or more parent United States patent applications perform the method or a portion of the method.

In some embodiments, one or more licensors of the one or more parent United States patent applications perform the method or a portion of the method.

In some embodiments, one or more licensees of the one or more parent United States patent applications perform the method or a portion of the method.

In some embodiments, one or more inventors of the United States patent application perform the method or a portion of the method.

In some embodiments, one or more applicants of the United States patent application perform the method or a portion of the method.

In some embodiments, one or more assignors of the United States patent application perform the method or a portion of the method.

In some embodiments, one or more assignees of the United States patent application perform the method or a portion of the method.

In some embodiments, one or more licensors of the United States patent application perform the method or a portion of the method.

In some embodiments, one or more licensees of the United States patent application perform the method or a portion of the method.

In some embodiments, one or more inventors of the United States patent perform the method or a portion of the method.

In some embodiments, one or more applicants of the United States patent perform the method or a portion of the method.

In some embodiments, one or more assignors of the United States patent perform the method or a portion of the method.

In some embodiments, one or more assignees of the United States patent perform the method or a portion of the method.

In some embodiments, one or more licensors of the United States patent perform the method or a portion of the method.

In some embodiments, one or more licensees of the United States patent perform the method or a portion of the method.

In some embodiments, one or more inventors of the claim perform the method or a portion of the method.

In some embodiments, one or more inventors of the patent or patent application perform the method or a portion of the method.

In some embodiments, one or more applicants of the patent or patent application perform the method or a portion of the method.

In some embodiments, one or more assignors of the patent or patent application perform the method or a portion of the method.

In some embodiments, one or more assignees of the patent or patent application perform the method or a portion of the method.

In some embodiments, one or more licensors of the patent or patent application perform the method or a portion of the method.

In some embodiments, one or more licensees of the patent or patent application perform the method or a portion of the method.

In some embodiments, one or more registered patent agents perform the method or a portion of the method.

In some embodiments, one or more attorneys perform the method or a portion of the method.

In some embodiments, one or more registered patent attorneys perform the method or a portion of the method.

In some embodiments, one or more law firms perform the method or a portion of the method.

In some embodiments, software performs the method or a portion of the method.

In some embodiments, the software performs automated drafting of a response document that responds to a document of record in the legal proceeding; the software comprises an algorithm that performs the automated drafting; the algorithm has rules; and communicated content communicated by each communicating step of the method is a product of a rule of the algorithm.

In some embodiments, the method comprises the automated drafting of a response document that responds to a document of record in the legal proceeding; the automated drafting is performed by an algorithm that has rules; and communicated content communicated by each communicating step of the method is a product of a rule of the algorithm.

In some embodiments, the legal proceeding is litigation; the document of record is a brief; and the response document is a reply brief.

In some embodiments, the legal proceeding is patent examination before the USPTO; the document of record is an Office Action; the response document is a Response to the Office Action; and the content consists of one or both of arguments and remarks of the Response.

The term “consists of” and derivatives thereof such as “consisting of” refer to closed sets, for example, such that, “content [that] consists of one or both of arguments and remarks of the Response,” cannot also comprise any additional content beyond “the arguments and [/or] remarks of the Response.”

In some embodiments, the legal proceeding is patent examination before the USPTO; the document of record is a Non-Final Rejection or a Final Rejection; the response document is a Response to the Non-Final Rejection or Final Rejection; and the content consists of one or both of arguments and remarks of the Response.

In some embodiments, the method is a patent method. In some embodiments, the patent method is any permutation of the preceding embodiments. In some specific embodiments, the patent method is any permutation of the preceding embodiments that grammar and logic allow. In some very specific embodiments, the patent method is any permutation of the preceding embodiments that grammar, logic, and legal procedure allow. Selected permutations may be identified, for example, in the claim set of U.S. 63/575,713, to which the instant application claims priority.

Various aspects of this disclosure relate to an education method to educate one or more people on patent strategy, comprising presenting a patent method to the one or more people.

The term “comprising” refers to an open set, for example, such that, “[a] n education method . . . comprising presenting the patent method . . . [to] one or more people,” may also include presenting the patent method to additional people. Each instance of the term “comprising” in this disclosure can optionally be replaced with the term “consisting of,” for example, to provide written description for claims that include the term “consisting of” instead of the term “comprising.” Each instance of the term “comprise(s)” in this disclosure can optionally be replaced with the term “consist(s) of,” for example, to provide written description for claims that include the term “consist(s) of” instead of the term “comprise(s).”

In some embodiments, the one or more people perform the patent method or a portion of the patent method after the presenting.

In some embodiments, the one or more people perform the patent method after the presenting.

In some embodiments, the method comprises presenting in an electronic format such as on a website, in an electronic document, or in software.

In some embodiments, the method comprises presenting in a written format such as in a handout or in a book.

In some embodiments, the method comprises presenting in a audiovisual format such as in a video, in a podcast, or in an audiobook.

In some embodiments, the method comprises presenting in a verbal format such as in an in-person meeting or during a video conference.

Patent applications and patents that have a prosecution history that is a product of a method described in this disclosure generally have greater value than patent applications and patents that have prosecution histories that set forth arguments of different facts, for example, because narrowing claim amendments are often necessary to overcome subject-matter eligibility rejections.

In some embodiments, the method comprises presenting content to demonstrate patent enforcement issues that may result from failing to adopt the patent method.

In some embodiments, the one or more people comprise one or more owners, directors, and employees of a business entity that owns patent assets.

In some embodiments, the one or more people comprise one or more attorneys and staff of a law firm that prosecutes patent applications.

In some embodiments, the one or more people comprise one or more attorneys and staff of a law firm that litigates patents.

In some embodiments, the one or more people comprise one or more patent agents.

In some embodiments, the one or more people comprise one or more attorneys.

In some embodiments, the one or more people comprise one or more patent attorneys.

In some embodiments, the one or more people comprise one or more owners, directors, and employees of a business entity that develops software for patent professionals.

In some embodiments, the one or more people comprise one or more attendees of a seminar, meeting, or conference of a professional organization. In some specific embodiments, the one or more people comprise one or more attendees of a seminar, meeting, or conference of a bar association, patent law association, intellectual property law association, patent owners association, intellectual property owners association, or trade association.

In some embodiments, the one or more people comprise one or more law students.

In some embodiments, the one or more people comprise one or more attendees of a law school course.

In some embodiments, the one or more people comprise one or more USPTO patent examiners.

In some embodiments, the one or more people comprise one or more judges.

In some embodiments, the one or more people comprise one or more PTAB judges.

In some embodiments, the one or more people comprise one or more United States District Court judges.

In some embodiments, the one or more people comprise one or more Circuit Judges of the United States Court of Appeals for the Federal Circuit.

In some embodiments, the one or more people comprise one or more Justices of the Supreme Court of the United States.

In some embodiments, the one or more people comprise a Commissioner for Patents or Acting Commissioner for Patents of the USPTO.

In some embodiments, the one or more people comprise one or more Deputy Commissioners for Patents and Acting Deputy Commissioners for Patents of the USPTO.

In some embodiments, the one or more people comprise a Director or Acting Director of the USPTO.

In some embodiments, the one or more people comprise one or more Representatives of the United States House of Representatives.

In some embodiments, the one or more people comprise one or more Senators of the United States Senate.

In some embodiments, the presenting is performed by one or more attorneys.

In some embodiments, the presenting is performed by one or more patent attorneys.

In some embodiments, the presenting is performed by one or more patent agents.

In some embodiments, the presenting is performed by a law firm.

In some embodiments, the presenting is presenting to market software to the one or more people.

In some embodiments, the presenting is presenting to train the one or more people on software that performs the patent method or a portion of the patent method.

Various aspects of this disclosure relate to a United States patent application that comprises a prosecution history that is a product of any method of this disclosure such as a strategic method or a patent method.

Various aspects of this disclosure relate to a United States patent that comprises a prosecution history that is a product of any method of this disclosure such as a strategic method or a patent method.

Various aspects of this disclosure relate to a United States patent application that comprises a litigation history that is a product of any method of this disclosure such as a strategic method or a patent method.

Various aspects of this disclosure relate to a United States patent that comprises a litigation history that is a product of any method of this disclosure such as a strategic method or a patent method.

Various aspects of this disclosure relate to a United States patent application that discloses a method of patent prosecution of this disclosure such as a strategic method or a patent method.

Various aspects of this disclosure relate to a United States patent application that claims a method of patent prosecution of this disclosure such as a strategic method or a patent method.

Various aspects of this disclosure relate to a United States patent application that discloses a method of patent litigation of this disclosure such as a strategic method or a patent method.

Various aspects of this disclosure relate to a United States patent application that claims a method of patent litigation of this disclosure such as a strategic method or a patent method.

Various aspects of this disclosure relate to a United States patent that discloses a method of patent prosecution of this disclosure such as a strategic method or a patent method.

Various aspects of this disclosure relate to a United States patent that claims a method of patent prosecution of this disclosure such as a strategic method or a patent method.

Various aspects of this disclosure relate to a United States patent that discloses a method of patent litigation of this disclosure such as a strategic method or a patent method.

Various aspects of this disclosure relate to a United States patent that claims a method of patent litigation of this disclosure such as a strategic method or a patent method.

Various aspects of this disclosure relate to a United States patent application that discloses any method of this disclosure such as a strategic method or a patent method.

Various aspects of this disclosure relate to a United States patent application that claims any method of this disclosure such as a strategic method or a patent method.

Various aspects of this disclosure relate to a United States patent that discloses any method of this disclosure such as a strategic method or a patent method.

Various aspects of this disclosure relate to a United States patent that claims any method of this disclosure such as a strategic method or a patent method.

### EXEMPLIFICATION

The Example. An example appellate brief to challenge a rejection under § 101 before the PTAB.

The following text sets forth an example of language and references that implement various methods of this disclosure in proceedings to contest a rejection of a patent application before the PTAB. The following text is subject to copyright and may not be reproduced except in the context of this entire patent specification or as otherwise agreed upon by the copyright holder.

### The First Issue

Are judicial exceptions constitutional in view of the Supremacy Clause of the U.S. Constitution?

All pending claims are patent eligible under § 101 because the Supremacy Clause of the U.S. Constitution prohibits judicial exceptions to acts of Congress made in pursuance of the Constitution.

The Final Rejection states that the original claims fell within the statutory categories of § 101. This analysis ends the subject-matter eligibility inquiry in view of the Supremacy Clause of the Constitution, which prohibits exceptions to acts of Congress made in pursuance of the Constitution. All pending claims are therefore patent eligible as a matter of law.

a. The Supremacy Clause of the U.S. Constitution prohibits exceptions to the Patent Act.

“Under our constitutional framework, federal courts do not sit as councils of revision, empowered to rewrite legislation in accord with their own conceptions of prudent public policy.” United States v. Rutherford, 442 U.S. 544, 555 (1979); accord United States v. Dubilier Condenser Corp., 289 U.S. 178, 199 (1933) (“[Courts] should not read into the patent laws limitations and conditions which the legislature has not expressed.”). Judicial exceptions, “in which the letter of the statute is not deemed controlling . . . are few and exceptional, and only arise when there are cogent reasons for believing that the letter [of the law] does not fully and accurately disclose the intent [of the lawmaker].” United States v. Goldenberg, 168 U.S. 95, 103 (1897). Limited sources may be consulted in identifying intent, which include, “the reports of the committee of each house.” Church of the Holy Trinity v. United States, 143 U.S. 457, 465 (1892); accord Diamond v. Diehr, 450 U.S. 175, 182 (1981). When these limited sources are silent, then intent may only be divined from an absurd result “so gross as to shock the general moral or common sense.” Crooks v. Harrelson, 282 U.S. 55, 60 (1930) (“And there must be something to make plain the intent of Congress that the letter of the statute is not to prevail.”). Past Supreme Courts cautioned:
Courts have sometimes exercised a high degree of ingenuity in the effort to find justification for wrenching from the words of a statute a meaning which literally they did not bear . . . . But an application of the principle so nearly approaches the boundary between the exercise of the judicial power and that of the legislative power as to call rather for great caution and circumspection . . . to avoid usurpation of the latter.
   Id.; accord Diamond v. Chakrabarty, 447 U.S. 303, 315 (1980) (“It is, of course, correct that Congress, not the courts, must define the limits of patentability.”).

The Supremacy Clause of the U.S. Constitution prohibits judicial exceptions to federal statute. “This Constitution, and the Laws of the United States which shall be made in Pursuance thereof . . . shall be the supreme Law of the Land; and the Judges in every State shall be bound thereby.” U.S. CONST. art. VI, cl. 2. While courts more frequently apply the Supremacy Clause to preempt state law, the Supremacy Clause applies equally to stare decisis. Gamble v. United States, 139 S. Ct. 1960, 1984-85 (2019) (Thomas, J., concurring).

The constitutional basis for the patent statute is clear. “The Congress shall have the power . . . . To promote the Progress of Science and useful Arts, by securing for limited Times to Authors and Inventors the exclusive Right to their respective Writings and Discoveries.” U.S. CONST. art. I, § 8, cl. 8. No court wields any power to create exceptions to acts of Congress made in pursuance of the Constitution. Expanded Metal Co. v. Bradford, 214 U.S. 366, 382 (1909) (“[I] t is not the province of the courts to so limit the [patent] statute as to deprive meritorious inventors of its benefits.”); McClurg v. Kingsland, 42 U.S. (1 How.) 202, 206 (1843) (“[T] he powers of Congress to legislate upon the subject of patents is plenary by the terms of the Constitution, . . . there are no restraints on its exercise.”). If any court purported to do so, then this Board is bound to reject the precedent. Gamble, 139 S. Ct. at 1985-86. Chief Justice John Marshall explained:
[I] n declaring what shall be the supreme law of the land, the constitution itself is first mentioned; and not the laws of the United States generally, but those only which shall be made in pursuance of the constitution, have that rank.
Thus, the particular phraseology of the constitution of the United States confirms and strengthens the principle, supposed to be essential to all written constitutions, that a law repugnant to the constitution is void; and that courts, as well as other departments, are bound by that instrument.
   Marbury v. Madison, 5 U.S. (1 Cranch) 137, 180 (1803).
   b. Subject-matter eligibility jurisprudence and USPTO policy overlook the Supremacy Clause.

The patent bar failed to ever argue that exceptions to § 101 violate the Supremacy Clause, and the courts failed to ever raise the issue sua sponte. As a result of these failures, the patent bar, courts, and USPTO continue to find that clearly erroneous precedent remains good law. E.g., Parker v. Flook, 437 U.S. 584 (1978). See also id. at 599-00 (Stewart, J., dissenting) (“The issue here is whether a claimed process loses its status of subject-matter patentability simply because one step in the process would not be patentable subject matter if considered in isolation . . . . [T] he claimed process clearly meets the standards of subject-matter patentability of § 101” (footnote omitted); joined by Chief Justice Warren E. Burger and his successor Associate Justice William H. Rehnquist). Then, former USPTO Commissioner John Doll—who joined the USPTO as an examiner and lacked any training in constitutional law—embedded these egregious errors into USPTO procedure. John Doll, Interim Guidelines for Examination of Patent Applications for Patent Subject Matter Eligibility, OFF. GAZ. PAT. & TRADEMARK OFFICE, Nov. 22, 2005, at 13, Part IV.C.1 (codified as amended at MPEP § 2106.04 (I) (9th ed. Rev. 07.2022 February 2023) [hereinafter MPEP]). Inventors Bernard Bilski and Rand Warsaw first challenged this unconstitutional framework, but neither their attorneys nor the en banc Federal Circuit nor the Supreme Court nor any amici noticed the clear violation of the Supremacy Clause inherent to Commissioner Doll's procedure. E.g., Bilski v. Kappos, 561 U.S. 593 (2010). And no one subsequently raised the issue—until now.

c. This Board must apply the Supremacy Clause and may not simply defer to USPTO policy or judicial precedent.

The outstanding question is whether this Board is bound to apply erroneous precedent or whether it possesses the power defend the Constitution and pen the most important PTAB opinion in USPTO history. Stare decisis “does not compel [judges] to follow a past decision when its rationale no longer withstands ‘careful analysis.’” Arizona v. Gant, 556 U.S. 332, 348 (2009) (quoting Lawrence v. Texas, 539 U.S. 558, 577 (2003)). Stare decisis is instead “at its weakest” when applying constitutional law. Dobbs v. Jackson Women's Health Org., 597 U.S. 215, 264 (2022); Agostini v. Felton, 521 U.S. 203, 235 (1997). Justice Louis Brandeis noted, “[t] he reasons why this Court should refuse to follow an earlier constitutional decision which it deems erroneous are particularly strong where the question presented is one of applying, as distinguished from . . . interpreting, the Constitution.” Burnet v. Coronado Oil & Gas Co., 285 U.S. 393, 410 (1932) (Brandeis, J., dissenting); accord Jackson Women's Health, 597 U.S. at 341-42 (describing Justice Brandeis's dissent as canon). In this case, the outstanding question is simply whether this Board should apply the Supremacy Clause, which mandates that this Board break with both precedent and USPTO policy.

This Board must break with both precedent and USPTO policy at least because each judge on this Board swore an oath to uphold the Constitution. This Board may not elevate precedent above acts of Congress made in pursuance of the Constitution without violating these oaths. Cf. Gamble, 139 S. Ct. at 1985 n.5 (“[T] he Executive likewise must independently evaluate the constitutionality of their actions; they take an oath to uphold the Constitution, not to blindly follow judicial precedent.”). Justice Clarence Thomas explained:
The Constitution's supremacy is also reflected in its requirement that all judicial officers, executive officers, Congressmen, and state legislators take an oath to “support this Constitution.” Notably, the Constitution does not mandate that judicial officers swear to uphold judicial precedents. And the Court has long recognized the supremacy of the Constitution with respect to executive action.
The same goes for judicial precedent. The “judicial Power” must be understood in light of “the Constitution's status as the supreme legal document” over “lesser sources of law.” This status necessarily limits “the power of a court to give legal effect to prior judicial decisions” that articulate demonstrably erroneous interpretations of the Constitution because those prior decisions cannot take precedence over the Constitution itself. Put differently, because the Constitution is supreme over other sources of law, it requires [judges] to privilege its text over [their] own precedents when the two are in conflict.
The same principle applies when interpreting statutes and other sources of law: If a prior decision demonstrably erred in interpreting such a law, federal judges should exercise the judicial power—not perpetuate a usurpation of the legislative power and correct the error. A contrary rule would permit judges to “substitute their own pleasure” for the law.
The true irony of our modern stare decisis doctrine lies in the fact that proponents of stare decisis tend to invoke it most fervently when the precedent at issue is least defensible. It is no secret that stare decisis has had a “ratchet-like effect,” cementing certain grievous departures from the law into the Court's jurisprudence.
[The] judicial duty to interpret the law requires adherence to the original meaning of the text. For that reason, we should not invoke stare decisis to uphold precedents that are demonstrably erroneous.
   Id. at 1985, 1988-89 (emphasis added) (citations omitted); accord Marbury, 5 U.S. at 180 (“Why does a judge swear to discharge his duties agreeably to the constitution of the United States, if that constitution forms no rule for his government? if it is closed upon him, and cannot be inspected by him? If such be the real state of things, this is worse than solemn mockery. To prescribe, or to take this oath, becomes equally a crime.”).
   d. The pending claims feature methods, which constitute patent-eligible subject matter under § 101.

The pending claims feature methods. § 101 states, “[w] hoever invents or discovers any new and useful process . . . may obtain a patent therefor, subject to the conditions and requirements of this title,” and not, “subject to the conditions of federal common law or USPTO policy.” § 100 (b) clarifies, “[t] he term process means process, art or method.” The Committee Reports that the House and Senate both published in enacting § 101 each state, “[t] he definition of ‘process’ has been added in section 100 to make it clear that ‘process or method’ is meant, and also to clarify the present law as to the patentability of certain types of processes or methods as to which some insubstantial doubts have been expressed.” H.R. REP. NO. 82-1923, at 6 (1952) (emphasis added); accord S. REP. NO. 82-1979, at 5 (1952). See also Diehr, 450 U.S. at 182 (“[I] n order to determine its meaning [the statutory term ‘process’] we may not be unmindful of the Committee Reports accompanying the 1952 Act.”). In enacting § 101, Congress heard testimony that, “[t] he term ‘art’ is broader than the term ‘process,’” and documented no contrary perspective, which supports a liberally-broad definition of “process” as defined in § 100 (b) to include “process, art or method” rather than a narrow definition that excludes certain types of processes or methods from patentability. Patent Law Codification and Revision: Hearing on H.R. 3760 Before Subcomm. No. 3 of the Comm. on the Judiciary, 82d Cong. 51 (1951).

No court ever found that Congress intended a narrow definition of “process” that excludes certain types of processes or methods from patentability. The Benson Court stated, for example, “[t] he question is whether the method described and claimed is a ‘process’ within the meaning of the Patent Act.” Gottschalk v. Benson, 409 U.S. 63, 64 (1972). “Unfortunately, after stating that to be the question, the [Benson] Supreme Court opinion does not again advert to it and never decides it.” In re Christensen, 478 F.2d 1392, 1395 (C.C.P.A. 1973) (Rich, J., concurring). See also Bilski, 561 U.S. at 650-51 (Stevens, J., concurring) (“Judge Rich [was] the main drafter of the 1952 Act.”); BOB WOODWARD & SCOTT ARMSTRONG, THE BRETHREN 207 (1979) (stating that by the time 74-year-old Justice William O. Douglas drafted Benson—the first Supreme Court opinion to disregard the text of § 101-other Justices had “noticed a deterioration in the quality of Douglas's opinions; they had become increasingly superficial.”); Nat Hentoff, The Justice Breaks His Silence, PLAYBOY MAG., July 1991, at 120, 122 (quoting Justice William J. Brennan, Jr.) (“” [Justice Douglas's] last ten years on the Court were marked by the slovenliness of his writing and the mistakes that he constantly made. “”). In the absence of any finding of congressional intent to exclude certain types of methods from patentability, no legitimate basis exists for judicial exceptions to § 101.

Following Benson, subsequent Supreme Courts found a mandate to ignore the text of § 101 in favor of simply applying precedent. Flook states, for example, “[t] he holding [of Benson] forecloses a purely literal reading of § 101,” and, “[i] t is our duty to construe the patent statutes as they now read, in light of our prior precedents.” Flook, 437 U.S. at 589, 596 (majority opinion). See also Bilski, 561 U.S. at 610 (majority opinion) (“In Flook, the Court considered the next logical step after Benson.”). Alice Corp. Party v. CLS Bank Int'l states, “we tread carefully in construing this exclusionary principle [and not the statute] lest it swallow all of patent law.” 573 U.S. 208, 217 (2014). Both Flook and Alice violate the Supremacy Clause by elevating federal common law above an act of Congress made in pursuance of the Constitution, namely the Patent Act of 1952 made in pursuance of Article I, section 8, clause 8.

In view of the foregoing, judicial exceptions to § 101 are unconstitutional, and all pending claims are patent eligible as a matter of law because they claim methods. This Board is therefore positioned to author an opinion that outshines every Supreme Court Justice who ever found an exception to § 101, every Federal Circuit judge in history, countless District Court judges, the legal teams of Acting Director Doll and every subsequent Director, every PTAB judge in history, and the entire patent bar.

What is claimed is:

1. A method to demonstrate the subject-matter eligibility of a patent claim, comprising identifying that a judicial exception to statutory subject matter violates the Supremacy Clause of the United States Constitution, wherein the patent claim is a claim of a patent or a patent application.

2. The method of claim 1, wherein the statutory subject matter is set forth in Title 35, Section 101 of the United States Code (35 U.S.C. § 101).

3. The method of claim 2, wherein the judicial exception is selected from a rationale set forth in Alice Corp. Party v. CLS Bank Int'l, 573 U.S. 208 (2014), Ass'n for Molecular Pathology v. Myriad Genetics, Inc., 569 U.S. 576 (2013), Mayo Collaborative Servs. v. Prometheus Labs., Inc., 566 U.S. 66 (2012), Bilski v. Kappos, 561 U.S. 593 (2010), Parker v. Flook, 437 U.S. 584 (1978), Gottschalk v. Benson, 409 U.S. 63 (1972), or Funk Bros. Seed Co. v. Kalo Inoculant Co., 333 U.S. 127 (1948).

4. A method to obtain a United States patent, comprising paying an issue fee in a United States patent application that has a prosecution history before the United States Patent & Trademark Office, wherein:
a portion of the prosecution history is a product of a method according to claim 3; and
the United States patent grants from the United States patent application following payment of the issue fee.

5. A method to maximize the enforcement value of a United States patent that has a serial number, comprising labeling one or both of a product and marketing materials with the serial number to indicate that either the product or a subject of the marketing materials is protected by the United States patent, wherein:
the United States patent has a prosecution history before the United States Patent & Trademark Office; and
a portion of the prosecution history is a product of a method according to claim 3.

6. A method to maintain a United States patent in force, comprising paying a maintenance fee to maintain the United States patent in force, wherein:
the United States patent has a prosecution history before the United States Patent & Trademark Office; and
a portion of the prosecution history is a product of a method according to claim 3.

7. A method to enforce a United States patent, comprising asserting an infringement claim of infringement of the United States patent in either a United States federal court established under Article III of the Constitution of the United States or the United States International Trade Commission, wherein:
the United States patent has a prosecution history before the United States Patent & Trademark Office; and
a portion of the prosecution history is a product of a method according to claim 3.

8. The method of claim 4, wherein:
the portion of the prosecution history comprises immediate prosecution history of an immediate United States patent application from which the United States patent granted; and
the patent or patent application is the immediate United States patent application.

9. The method of claim 4, wherein:
the portion of the prosecution history comprises parent prosecution history of one or more parent United States patent applications to which the United States patent claims priority; and
the patent or patent application is a parent United States patent application of the United States patent and the United States patent application.

10. The method of claim 3, wherein the identifying is performed during a legal proceeding that contests the patentability of the claim, and the legal proceeding has a record.

11. The method of claim 10, wherein:
the legal proceeding is a proceeding before the Patent Trial and Appeal Board of the United States Patent & Trademark Office; and
the legal proceeding is a Post Grant Review.

12. The method of claim 10, wherein the legal proceeding is a proceeding before either a court established under Article III of the Constitution of the United States or the United States International Trade Commission.

13. The method of claim 10, comprising obtaining a damages award for infringement of the claim.

14. The method of claim 10, comprising obtaining an injunction that enjoins a person from infringing the claim, wherein the person is a natural person or a legal entity.

15. The method of claim 10, comprising executing an agreement that settles the legal proceeding.

16. The method of claim 1, wherein one or more attorneys perform the method.

17. A United States patent, comprising a prosecution history that is a product of a method according to claim 1.

18. A United States patent, comprising a litigation history that is a product of a method according to claim 1.

19. The patent or patent application of claim 1.

20. An education method to educate one or more people on patent strategy, comprising presenting the method of claim 1 one or more people.
